(19) United States
(12) Patent Application Publication
(10) Pub. No.: US 2022/0016453 A1
(43) Pub. Date: Jan. 20, 2022

(54) ANTIVIRAL FACE MASKS AND AIR FILTERS

(71) Applicant: CALGON CARBON CORPORATION, Moon Township, PA (US)

(72) Inventors: Robert BROWN, Hougton le Spring (GB); Paul CURTIS, Hougton le Spring (GB)

(73) Assignee: CALGON CARBON CORPORATION, Moon Township, PA (US)

(21) Appl. No.: 17/377,028

(22) Filed: Jul. 15, 2021

Related U.S. Application Data
(60) Provisional application No. 63/052,047, filed on Jul. 15, 2020.

(51) Int. Cl. A62B 23/00; B32B 5/02; B32B 7/02; B32B 5/26; D04H 3/16; D04H 3/007

(52) U.S. Cl. CPC A62B 23/00; B32B 5/022; B32B 7/02; B32B 5/277; D04H 3/16; D04H 3/007; D10B 2509/00; D10B 2321/022; D10B 2101/12; B32B 2262/0253; B32B 2262/106; B32B 2535/00; D10B 2321/021

(57) ABSTRACT

Air filters and masks containing activated carbon cloth material, optionally with silver included, are described that are effective at removing virus from the air, immobilizing, and inactivating. The filters and masks can immobilize and inactivate a virus. The filters and masks are useful for protecting a user against coronavirus such as SARS-CoV-2.

### CROSS-REFERENCE TO RELATED APPLICATIONS

This application claims priority to U.S. Provisional Application No. 63/052,047 filed Jul. 15, 2020, which is hereby incorporated by reference in its entirety.

### FIELD

The present disclosure generally relates to filters for use in face masks and more particularly to filters that can be used to remove viruses from the air.

### BACKGROUND

Face masks and air filters are an increasingly important part of the personal protective equipment arsenal. Consistent and proper use of masks can slow or eliminate spread of pathogens such as bacteria and viruses, from common cold to more serious and rare events such as H1N1, SARS-CoV, and SARS-CoV-2 viral infections.

Face masks and air filters are used both by health care professionals as well as by members of the general public. They can be used both as a preventative measure by people who are not already infected, as well as by those who are already infected to prevent the spread of a virus, whether they are symptomatic or not. Most commonly used conventional filters, such as N95 masks, act as a physical barrier to the passage of pathogens but are not designed to eliminate the pathogen itself or specifically immobilize it. Despite widespread use of masks in the COVID-19 pandemic, there still exists a need for more effective masks that can reduce pathogen count and viability in air that passes through the mask or air filter.

### SUMMARY

The present disclosure provides methods for filtering air suspected of containing coronavirus are described. In one aspect, the present disclosure provides A method of filtering an air stream that contains a virus or which is suspected of containing the virus comprising: passing an input air stream from an inlet face through a layered composite to an output face and thereby producing an output air stream having a virus concentration that is less than the virus concentration in the input air stream, wherein the layered composite comprises: an inner layer oriented towards or constitutes the inlet face; at least one layer of activated carbon cloth adjacent to the inner layer; and an outer layer comprising a non-woven polymer, the outer layer oriented towards or constitutes the outlet face and adjacent to the at least one layer of the activated carbon cloth, wherein the layered composite is contained within a filter or a face mask.

In one embodiment, the activated carbon cloth comprises about 0.1% w/w to about 3.5% w/w silver.

In one embodiment, the activated carbon cloth comprises about 0.1% w/w to about 0.5% w/w silver.

In one embodiment, the polymer is selected from the group consisting of a polyolefin, polyester, polyurethane, an acrylic polymer, and any combination thereof.

In one embodiment, the outer layer comprises spunbond polypropylene.

In one embodiment, the spunbond polypropylene has a weight of about 40 g/cm² to about 60 g/cm².

In one embodiment, the inner layer comprises a spunbond polyolefin.

In one embodiment, the layered composite further comprises a protective layer between the at least one layer of activated carbon cloth and the outer layer.

In one embodiment, the protective layer comprises a non-woven polyolefin.

In one embodiment, the protective layer comprises melt-blown polyethylene.

In one embodiment, the protective layer has a weight of about 40 g/cm² to about 70 g/cm².

In one embodiment, the layered composite comprises one or two layers of activated carbon cloth.

In one embodiment, the layered composite comprises one layer of activated carbon cloth.

In one embodiment, the activated carbon cloth material is woven activated carbon fiber.

In one embodiment, the virus is a coronavirus.

In one embodiment, the virus is SARS-CoV-2.

In one embodiment, the concentration of virus in the output air stream is less than about 10% of the concentration of virus in the input air stream.

In one embodiment, the concentration of virus in the output air stream is less than about 5% of the concentration of virus in the input air stream.

In one embodiment, the concentration of virus in the output air stream is less than 1% of the concentration of virus in the input air stream.

In one embodiment, at least a portion of the detectable virus is retained within the layered composite has a viability reduced by at least about 90% after about six hours of contact with the layered composite.

In one embodiment, at least a portion of the detectable virus is retained within the layered composite has a viability reduced by at least about 95% after about six hours of contact with the layered composite.

In one embodiment, at least a portion of the detectable virus is retained within the layered composite has a viability reduced by at least about 98% after about six hours of contact with the layered composite.

In one embodiment, the layered composite is contained within a face mask.

In one embodiment, the activated carbon cloth material comprises silver ions at a concentration of at least about 0.2% w/w.

In one embodiment, the activated carbon cloth material comprises silver ions at a concentration of at least about 0.3% w/w.

In one embodiment, the layered composite has an air permeability of at least about 12 cm³/cm²/second at 10 mm water pressure.

In one embodiment, the layered composite has an air permeability of at least about 15 cm³/cm²/second at 10 mm water pressure.

In another aspect, the present disclosure provides a method of filtering an air stream that contains a coronavirus or which is suspected of containing a coronavirus comprising: passing an input air stream from an inlet face through a layered composite to an output face and thereby producing an output air stream having a virus concentration that is less than the virus concentration in the input air stream, wherein the layered composite comprises: an inner layer oriented towards or constitutes the inlet face; at least one layer of activated carbon cloth adjacent to the inner layer and an outer layer comprising a non-woven polymer, the outer layer oriented towards or constitutes the outlet face and adjacent to the at least one layer of the activated carbon cloth, wherein the layered composite is contained within a filter or a face mask.

In one embodiment, the activated carbon cloth comprises about 0.1% w/w to about 3.5% w/w silver.

In one embodiment, the outer layer comprises spunbond polypropylene.

In one embodiment, the spunbond polypropylene has a weight of about 40 g/cm² to about 60 g/cm².

In one embodiment, the inner layer comprises a spunbond polyolefin.

In yet another aspect the present disclosure provides a layered composite for the removal of a virus from an air stream comprising: an inner layer oriented towards or constitutes the inlet face; at least one layer of activated carbon cloth adjacent to the inner layer, and an outer layer comprising a non-woven polymer, the outer layer oriented towards or constitutes the outlet face and adjacent to the at least one layer of the activated carbon cloth, wherein the layered composite is contained within a filter or a face mask.

In one embodiment, wherein the activated carbon cloth comprises about 0.1% w/w to about 3.5% w/w silver.

In one embodiment, wherein the activated carbon cloth comprises about 0.1% w/w to about 0.5% w/w silver.

In one embodiment, wherein the outer layer comprises spunbond polypropylene.

In one embodiment, wherein the spunbond polypropylene has a weight of about 40 g/cm² to about 60 g/cm².

In one embodiment, wherein the inner layer comprises a spunbond polyolefin.

In one embodiment, the layered composite further comprises a protective layer between the at least one layer of activated carbon cloth and the outer layer.

In one embodiment, the protective layer comprises a non-woven polyolefin.

In one embodiment, wherein the protective layer comprises melt-blown polyethylene.

In one embodiment, the protective layer has a weight of about 40 g/cm² to about 70 g/cm².

In one embodiment, the layered composite comprises one or two layers of activated carbon cloth.

In one embodiment, the layered composite comprises one layer of activated carbon cloth.

In one embodiment, the activated carbon cloth material is woven activated carbon fiber.

In another aspect, the present disclosure provides a layered composite for the removal of a virus from an air stream comprising: an inner layer oriented towards or constitutes the inlet face; at least one layer of activated carbon cloth adjacent to the inner layer, and an outer layer comprising a non-woven polymer, the outer layer oriented towards or constitutes the outlet face and adjacent to the at least one layer of the activated carbon cloth, wherein the layered composite is contained within a filter or a face mask.

In one embodiment, the activated carbon cloth comprises about 0.1% w/w to about 3.5% w/w silver.

In one embodiment, the spunbond polypropylene has a weight of about 40 g/cm² to about 60 g/cm².

In one embodiment, the inner layer comprises a spunbond polyolefin.

In one embodiment, the layered composite further comprises a protective layer between the at least one layer of activated carbon cloth and the outer layer.

In one embodiment, the protective layer comprises a non-woven polyolefin.

In one embodiment, the protective layer comprises melt-blown polyethylene.

In one embodiment, the protective layer has a weight of about 40 g/cm² to about 70 g/cm².

In one embodiment, the layered composite comprises one or two layers of activated carbon cloth.

In one embodiment, the layered composite comprises one layer of activated carbon cloth. In one embodiment, the activated carbon cloth material is woven activated carbon fiber.

In yet another aspect, the present disclosure provides a face mask comprising a layered composition according to any embodiment above.

### BRIEF DESCRIPTION OF THE DRAWINGS

FIG. 1 shows one embodiment of a four-layer composite comprising two activated carbon cloth layers.

FIG. 2 shows one embodiment of a five-layer composite comprising two activated carbon cloth layers and a protective membrane layer between the outer layer and the activated carbon cloth.

FIG. 3 shows one embodiment of a four-layer composite comprising one activated carbon cloth layer and a protective membrane layer between the outer layer and the activated carbon cloth.

FIG. 4 shows one embodiment of a three-layer composite comprising one activated carbon cloth layer between the outer layer and an inner layer.

### DETAILED DESCRIPTION

The invention disclosed herein is not limited to the particular systems, devices and methods described herein, as these may vary. The terminology used in the description is for the purpose of describing the particular versions or embodiments only, and is not intended to limit the scope, which is limited only by the appended claims.

The layered composites described herein may be effective for filtering and removing viral particles, in particular, coronavirus particles, from an air stream, thereby providing an article suitable for use in a medical capacity, such as in a mask or any place where filtration of viral particles is desired. As such, in any embodiment, the layered composites provided herein may be used to prevent the spread of a coronavirus in any environment, for example, from one person to another. Advantageously, the layered composites disclosed herein not only captures viral particles from an air stream but immobilizes them on and/or within the composite, preventing re-release of said particles into the air, for example, upon an exhale of a person wearing a mask, and further inactivates the viral particles thereby preventing future contamination from the viral particles captured by the composite, for example, when a wearer removes a mask and sets said mask on a table.

Therefore, in one aspect, the present disclosure provides a layered composite effective for capturing, immobilizing, and inactivating virus particles form an air stream, the layered composite comprising an inner layer oriented towards or constitutes the inlet face; at least one layer of activated carbon cloth adjacent to the inner layer, and an outer layer comprising a non-woven polymer, the outer layer oriented towards or constitutes the outlet face and adjacent to the at least one layer of the activated carbon cloth. In any embodiment, the activated carbon cloth may comprise silver, which may, in any embodiment, improve the capacity of a layered composite to inactivate virus immobilized therein or thereon.

As used herein, “outer layer” is used to describe a layer that, when considering a direction of air flow (e.g., an air stream), the air stream may enter the composite, passing through the outer layer before passing through the at least one layer of activated carbon cloth, and finally through the inner layer. For example, when used in a mask by a person, inhalation of air will cause ambient air to pass through the outer layer of the mask, into at least one layer of activated carbon cloth, and finally through the “inner layer” before being inhaled by the person. As used herein, “inner layer” describes the layer of the composite through which the air flow passes after exiting the at least one layer of activated carbon cloth. The location where the air stream enters a layered composite or filter assembly may, in any embodiment, be called the “inlet face” of the layered composite or filter assembly whereas the location where the air stream exits the filter assembly may be called the “outlet face” of the layered composite or filter assembly.

In any embodiment, a layered composite may comprise an outer layer, at least one layer of activated carbon cloth, and an outer layer, optionally comprising any additional layers such as a protective layer, as described herein. In any embodiment, a layered composite may consist of an outer layer, at least one layer of activated carbon cloth, and an outer layer, optionally with a protective layer as described herein.

The outer layer may comprise a material that is not particularly limited, and can include woven or non-woven materials. Such outer layer can include one or more of a non-woven polymer, such as a polyolefin, polyester, acrylic polymer, polyurethane, or any combination thereof. For example, in any embodiment, the outer layer may comprise one or more of non-woven polypropylene, polyethylene, polyester, polyurethane, and acrylic. The combination of the foregoing materials can be by way of polymer blends, copolymers, or mixed fibers or filaments of the foregoing materials. In any embodiment, outer layer material may have a weight of about 10 g/cm³ to about 150 g/cm³, such as about 20 g/cm³, about 30 g/cm³, about 40 g/cm³, about 50 g/cm³, about 70 g/cm³, about 70 g/cm³, or more than about 70 g/cm³. In any embodiment, for example, the outer layer may be a spunbond olefin, such as spunbond polypropylene, with a weight of about 30 g/cm³ to about 60 g/cm³, such as about 50 g/cm². For example, in any embodiment, the outer layer may comprise a spunbond polypropylene such as those sold under the DALTEX® tradename by Don & Low, Ltd (Scotland, UK). While not wishing to be bound by theory, it is hypothesized that the arrangement of matter in spunbond material may enhance the ability of said material to capture viral particles. The outer layer may have a thickness of about 0.15 mm to about 1 mm, such as about 0.18 mm, about 0.25 mm, about 0.30 mm, about 0.35 mm, about 0.40 mm, about 0.45 mm, about 0.50 mm, about 0.55 mm, about 0.6 mm, about 0.65 mm, about 0.7 mm, about 0.75 mm, about 0.8 mm, about 0.85 mm, about 0.9 mm, or about 0.95 mm.

The at least one layer of activated carbon cloth may comprise an activated carbon cloth of any type. Examples include knitted activated carbon fiber, woven activated carbon fiber, activated carbon fiber felt, and nonwoven activated carbon fiber. In any embodiment, for example, the activated carbon cloth may be a woven activated carbon cloth such as a FLEXZORB® activated carbon cloth available from Chemviron Carbon Limited, Tyne & Wear, UK, which has a surface density of 120 g/cm², a carbon tetrachloride activity of 55% to 70% w/w, an air permeability of 100 cm³/cm²/seconds at 10 mm and a thickness of 0.5 mm.

In any embodiment, the activated carbon cloth may further comprise silver at a concentration of at least about 0.1% w/w. Specific examples of silver ion concentrations include about 0.1% w/w, about 0.2% w/w, about 0.3% w/w, about 0.4% w/w, about 0.5% w/w, about 1% w/w, about 1.5% w/w, about 2% w/w, and ranges between any two of these values, such as about 0.1% w/w to about 0.5% w/w, about 1% w/w to about 4% w/w, and about 1.5% w/w to about 3.5% w/w.

A layered composite suitable for use in a filter assembly may comprise one activated carbon cloth or may comprise two or more activated carbon cloths, such as two, three, four, five, or six such layers, or any range between any aforementioned value, such as one to two layers, one to three layers, one to four layers, two to four layers, two to six layers, and so on. For example, in any embodiment, a layered composite suitable for use in a filter assembly may comprise one or two activated carbon layers. In any embodiment, a layered composite may comprise not more than two layers of activated carbon cloth. Each layer may be identical in one or more characteristic properties, such as one or more of type, weave, silver content, thickness, density, surface area, weight, tensile strength, flexibility, pore volume, iodine number, and absorption capacity, e.g., for acetic acid, or, in any embodiment, each layer may be different in one or more of these characteristic properties. In any embodiment, a layered composite may comprise an outer layer comprising a spunbond polyolefin (e.g., polypropylene) with a weight of about 30 g/cm² to about 60 g/cm² and one activated carbon cloth (e.g., woven) that optionally comprises about 0.1% w/w to about 3.5% w/w silver.

Optionally, between an outer layer and an activated carbon cloth layer, a layered composite may comprise one or more protective membrane layers. A protective membrane layer may comprise one or more of polypropylene, polyethylene, polyurethane, and polyester and have a weight of about 20 g/cm² to about 80 g/cm², such as abou² or about 60 g/cm². The protective membrane layer may comprise a non-woven material, for example, a melt-blown polypropylene.

A layered composite suitable for use in a filter assembly further comprises an inner layer. The inner layer may comprise a fusible interlining or interfacing, such as a resin or adhesive coating. For example, the inner layer may be a viscose non-woven material, such as a viscose non-woven layer made from a thermally fusible interlining, or may comprise a spunbond polymer. Suitable materials for the inner layer include, without limitation, polyvinyl chloride, polyvinyl acetate, polyester, polyamine, a polyolefin, such as polyethylene and polypropylene, and any combination thereof. An inner layer comprising a viscose non-woven material may have a weight of about 10 g/cm² to about 70 g/cm², such as about 20 g/cm² to about 50 g/cm², about 20 g/cm² to about 40 g/cm², or about 30 g/cm². For example, in any embodiment, a polyethylene thermally fusible dot coating, such as SLB30, may be used. An inner layer comprising a spunbond polymer, such as a spunbond polyolefin may have a weight of about 10 g/cm³ to about 150 g/cm³, such as about 20 g/cm³, about 30 g/cm³, about 40 g/cm³, about 50 g/cm³, about 70 g/cm³, about 70 g/cm³, or more than about 70 g/cm³. In any embodiment, the inner layer may be, for example, spunbond polypropylene having any of the aforementioned weights. As such, in any embedment, the material comprising an inner layer and an outer layer may be the same or similar, both comprising a spunbond polymer, a spunbond polyolefin, or a spunbond polypropylene, which may be of the same, about the same, or a different weight. In any embodiment, for example, the inner layer and outer layer may comprise spunbond polypropylene with a weight of about 40 g/cm³ to about 60 g/cm³, such as about 50 g/cm³. In such an embodiment, the layered composite may further comprise one or two woven activated carbon cloths optionally comprising about 0.1% w/w to about 3.5% w/w silver. Optionally, such an embodiment may further comprise a protective membrane layer between the activated carbon cloth and the outer layer, such as a layer of non-woven polyolefin (e.g., melt-blown polypropylene).

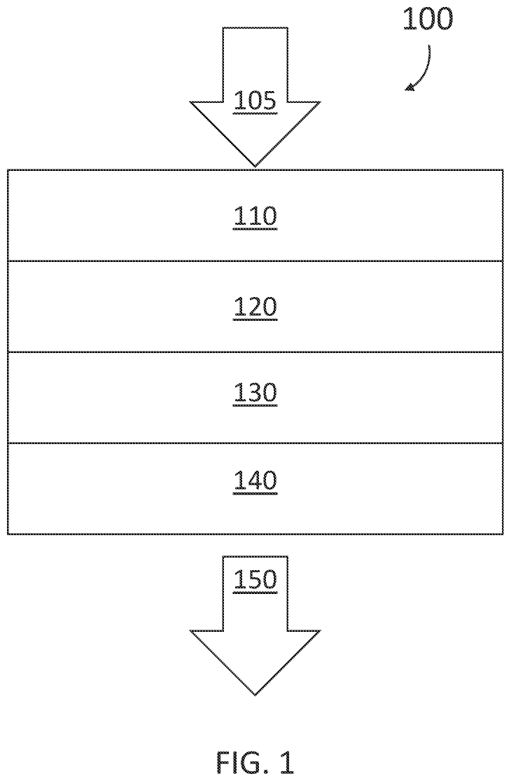

FIG. 1 provides one example of a layered composite comprising at least one layer of activated carbon cloth. In FIG. 1, a four-layer composite 100 comprises two layers of activated carbon cloth 120, 130, as described herein, between an inner layer 150 and an outer layer 110. Use of the layered composite shown in FIG. 1 may comprise, as shown, conveying an input air stream 105 through the four layers 110, 120, 130, 140, leaving as an output air stream 150. In FIG. 1, the direction of air flow is oriented as if a wearer is inhaling breath.

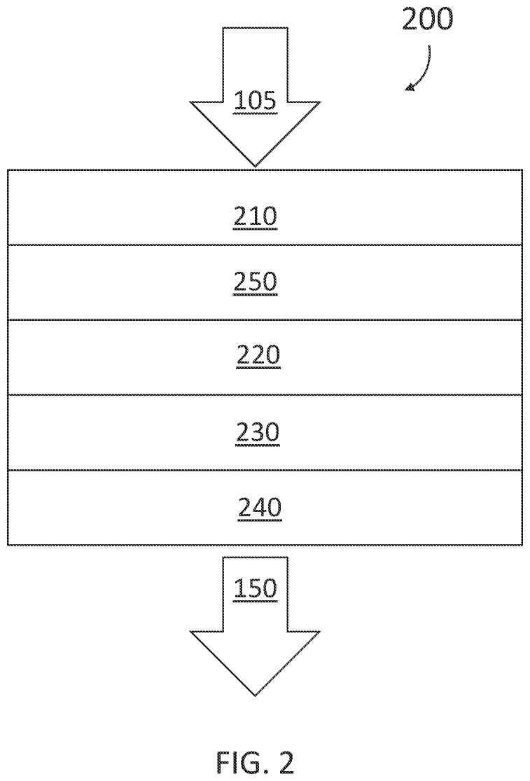

Another example of a layered composite 200 is depicted in FIG. 2, where a polypropylene melt-blown non-woven layer 250 is placed between the outer layer 210 and the first layer of activated carbon cloth 220. Input air stream 105 is shown as flowing from the top where output air stream 150 is shown as flowing towards the bottom. The layered composite 200 comprises an additional layer of activated carbon cloth 230, and an inner layer 240. The. In FIG. 2, the direction air flow is oriented as if a wearer is inhaling breath.

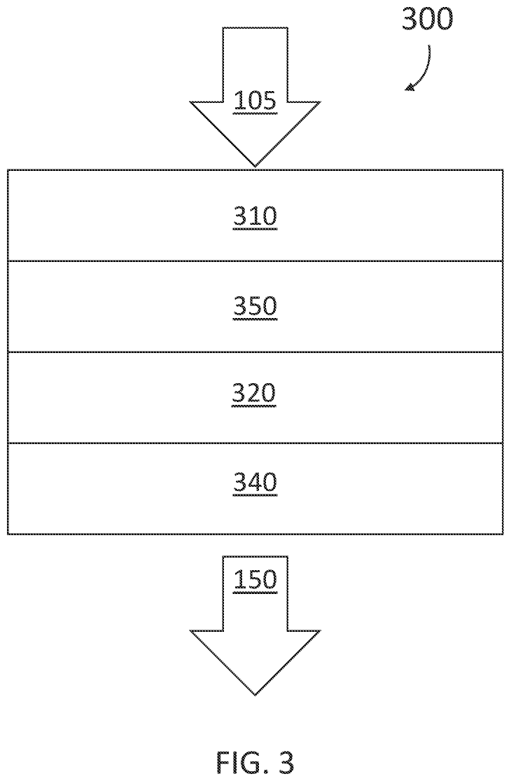

Another example of a layered composite 300 is depicted in FIG. 3, which comprise only a single layer of activated carbon cloth 320. Layered composite 300 comprises an outer layer 310, a polypropylene melt-blown non-woven layer 350, and an inner layer 340. In FIG. 3, the direction air flow is oriented as if a wearer is inhaling breath. Input air stream 105 is shown as flowing from the top where output air stream 150 is shown as flowing towards the bottom.

In another example of a four-layered composite, the inner layer may be made of the same material as the outer layer (e.g., non-woven polypropylene). Such a composite may further optionally comprise a protective membrane layer, such as a non-woven polypropylene melt-blown layer and one or more (e.g., 1 or 2) activated carbon cloth layers.

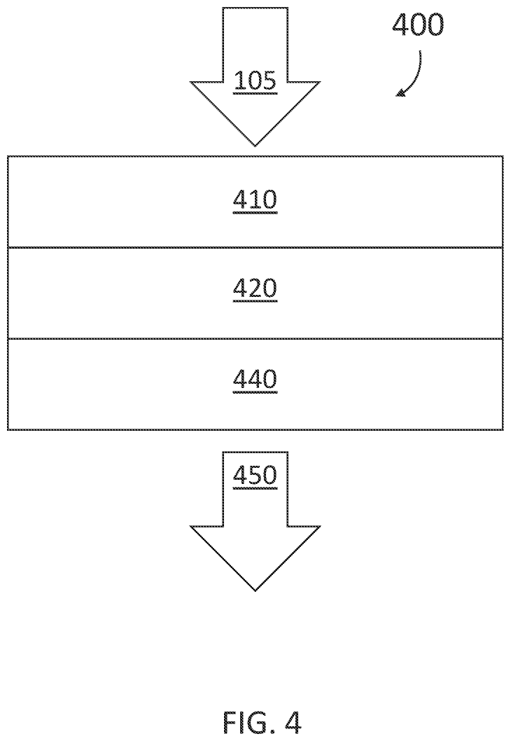

Yet another example of a layered composite 400 is depicted in FIG. 4, which comprise a single activated carbon cloth layer 420, an outer layer 440, and an inner layer 410. The outer layer 410 may comprise, as described above, a non-woven polyolefin such as polypropylene melt-blown non-woven material. In FIG. 4, the direction air flow is oriented as if a wearer is inhaling breath. Input air stream 105 is shown as flowing from the top where output air stream 150 is shown as flowing towards the bottom.

Methods of Preparing Activated Carbon Cloth

Preparing an activated carbon cloth may be carried out using any carbonization and activation process known to one skilled in the art. The process can be one step, two steps, or can be of a continuous batch nature. For example, carbonization may be carried out in an oxygen free atmosphere at temperatures of about 300° C. to about 900° C. In any embodiment, activation may be carried out in a steam or CO₂ atmosphere at any suitable temperature, such as 700° C. about 1000° C. The starting material may be any carbonaceous woven or non-woven material, for example, a viscose rayon or polyacrylonitrile.

Silver may be incorporated into the activated cloth by any method known in the art and in any form suitable for antiviral activity, such as elemental silver or silver ions.

For example, in any embodiment, silver may be incorporated by impregnation of the raw material or pre-fabricated activated carbon cloth via a solution of one or more silver halides. “Impregnated” as used herein means the silver securely resides in the cloth in any fashion, for example whether as a coating on fibers, located in interstitial spaces between fibers, embedded into fibers, or otherwise substantially attached and retained by the cloth throughout the intended uses described herein. The process of manufacture can be that described in U.S. Pat. No. 4,529,623, for example, which patent is incorporated herein by reference. The resulting activated carbon cloth has a microporous structure capable of attracting and capturing molecules.

One or more metals, such as silver, may be deposited to extend through the thickness of an activated carbon cloth, incorporated in an amount sufficient to enhance antiviral properties of the cloth, such as about 0.05% w/w to about 3% w/w of silver. In a preferred example, the metal is silver. The cloth thickness may be about 0.2 mm to about 2 mm having a weight in the range of about 100 g/m² to about 300 g/m² and an adsorption capacity for ethyl acetate in the range of about 20% to about 80% w/w. In any embodiment, the cloth may be activated carbon cloth FM10 (produced by Chemviron Carbon Cloth Division), impregnated with about 0.1% w/w to about 3.5% w/w silver, such as about 0.1% w/w to about 0.5% w/w, or about 0.3% w/w silver, having a nominal thickness of 0.5 mm, a weight of 120 g/m², and an adsorption capacity for ethyl acetate of 35% w/w. In another example, the cloth may be activated carbon cloth FM30K (produced by Chemviron Carbon Cloth Division), impregnated with 0.3% w/w silver, having a nominal thickness of 0.4 mm, a weight of 110 g/m², and an adsorption capacity for ethyl acetate of 35% w/w. In yet another example, the cloth may be activated carbon cloth FM50K (produced by Chemviron Carbon Cloth Division), impregnated with about 0.1% w/w to about 3.5% w/w silver, such as about 0.1% w/w to about 0.5% w/w, or about 0.3% w/w silver.

### Methods of Manufacturing a Layered Composite

The layers of a layered composite can be held together by any attachment mechanism that is positioned along all or a portion of the perimeter of the composite. Attachment mechanisms may also be placed elsewhere, provided they do not undesirably interfere with filtration or other features of the component as a filtration, capture, and virucidal component. Attachment mechanism can include, for example, stitching, fastening, adhesive, ultrasonic welding, needle punching, a melt welding, or any combination thereof. In any embodiment, the layers of a layered composite may be secured to each other by an adhesive, which may be heated and/or compressed to facilitate lamination. Any adhesive may be used, such as ethyl vinyl acetate, polyester, polyamide, or any combination thereof.

A layered composite may be incorporated into a filter assembly generally in any physical form, such as a facial mask, clothing such as a scarf, HVAC filter, air purifier filter, or the like. In some examples, the filter assembly is contained in a facial mask. As described above, in the case of a facial mask, respirator layer, or scarf, the input-to-output air stream direction is considered in the direction of a wearer's inhaled breath, bringing air into the wearer's lungs. In the case of a HVAC filter or air purifier filter, the input air stream is the airflow that arrives at or blown towards the filter assembly.

Methods of Use

A layered composite, as disclosed herein, comprising an outer layer, at least one layer of activated carbon cloth (optionally with 0.1% w/w to 3.5% w/w of silver), optionally a protective membrane layer, and an inner layer, as described above is particularly effective in capturing, immobilizing, and deactivating a virus, such as coronavirus, from an air stream. Therefore, in another aspect, the present disclosure provides a method of filtering an air stream that contains a virus or which is suspected of containing the virus comprising: passing an input air stream through a layered composite from an inlet face to an output face and thereby producing an output air stream having a virus concentration that is less than the virus concentration in the input air stream, wherein the layered composite comprises: an inner layer oriented towards or constitutes the inlet face; at least one layer of activated carbon cloth adjacent to the inner layer, and an outer layer oriented towards or constitutes the outlet face and comprising a spunbond polyolefin adjacent to the at least one layer of the activated carbon cloth, wherein the layered composite is contained within a filter or a face mask.

In some embodiments, there are disclosed a methods of filtering air suspected of containing a virus, such as a coronavirus, comprising providing a layered composite, as described above, within a filter assembly and conveying an air stream through the filter assembly, For example, the air may be conveyed through an inlet face of a filter assembly, where it is conveyed through the layered composite to an outlet face, exiting the composite and/or filter assembly (if the composite is provided therein) as an outlet air stream. In another example, the outer layer may be considered to be the inlet face, for example, if the layered composite is provided as a face mask. Similarly, air having passed through the layered composite may be conveyed through an outlet face of the filter assembly or, in any embodiment, the inner layer may be considered to be the outlet face, such as in a face mask.

In any embodiment, the virus may be a coronavirus, such as one from the four main sub-groupings: alpha, beta, delta, and gamma. Specific examples include 229E (alpha coronavirus), NL63 (alpha coronavirus), OC43 (beta coronavirus), HKU1 (beta coronavirus), MERS-CoV, SARS-CoV, and SARS-CoV-2. In some examples, the coronavirus is SARS-CoV-2. The virus can be an enveloped virus or a non-enveloped virus. Envelopes are formed of lipid bilayers that encases the virus. Non-enveloped viruses are generally more resistant to outside forces than are enveloped viruses. As used herein, “virus” is used to refer to particle capable of transmitting viral nucleic acid for replication, such as a virion. In some examples, the air is suspected of containing a coronavirus, but may not actually contain detectable coronavirus.

As described above, the outer layer of a layered composite may comprise a non-woven polymer, such as a spunbond polyolefin (e.g., polyethylene, polypropylene), having a weight of about 10 g/cm³ to about 150 g/cm³, such as about 20 g/cm³, about 30 g/cm³, about 40 g/cm³, about 50 g/cm³, about 70 g/cm³, about 70 g/cm³, or more than about 70 g/cm³. The at least one layer of activated carbon cloth may, in any embodiment, optionally comprise about 0.1% w/w silver to about 3.5% w/w silver and may be, for example, a woven or non-woven, preferably woven, fabric. The optional protective layer may comprise a non-woven polyolefin, such as polyethylene or polypropylene, for example, a melt-blown polypropylene material having a weight of about 20 g/cm² to about 80 g/cm², such as about 50 g/cm² or about 60 g/cm². The inner layer may comprise a viscose non-woven material or may be made from the same or similar material as the outer layer i.e., a spunbond polyolefin, such as polyethylene or polypropylene, having a weight of about 10 g/cm³ to about 150 g/cm³, such as about 20 g/cm³, about 30 g/cm³, about 40 g/cm³, about 50 g/cm³, about 70 g/cm³, about 70 g/cm³, or more than about 70 g/cm³. In any embodiment, a layered composite suitable for use in the methods disclosed herein may have an inner and outer layer that comprise the same or a similar material, such as a non-woven polymer, spunbond polymer, spunbond polyolefin, or spunbond polypropylene.

The layered composites disclosed herein are particularly effective at capturing (i.e. removing from the air stream) a virus, immobilizing the virus on or in one or more layers of the layered composite, and inactivating the virus immobilized on or in the layered composite thereby rendering the virus non-transmissible or non-infectious. As such, the methods disclosed herein are effective at generating an output air stream having a lower concentration of a virus than the concentration of the virus in the input air stream.

The efficacy of a layered composite to remove virus from an air stream can be measured in any conventional way. For example, the concentration of a virus (e.g., a coronavirus) in an input air stream can be compared to the concentration of virus in the output air stream. A percentage of virus captured or retained by a layered composite can be calculated, where higher values are more desirable. Alternatively, calculating the percentage of the concentration of virus in the output air stream relative to the input air stream can be calculated, where lower values are more desirable. For percentage captured or retained, the percentage can generally be any percentage. Examples of percentage captured or retained include at least about 90%, at least about 91%, at least about 92%, at least about 93%, at least about 94%, at least about 95%, at least about 96%, at least about 97%, at least about 98%, at least about 99%, at least about 99.9%, at least about 99.99%, at least about 99.999%, or any range between any two of these values. In an ideal case, 100% of virus would be captured or retained. Alternatively, performance can be measured in percentage transmitted through or not captured or retained. This percentage can be calculated as the percentage of concentration in the output air stream relative to the concentration of virus in the input air stream. This percentage can generally be any percentage. For example, the percentage can be less than 10%, less than 9%, less than 8%, less than 7%, less than 6%, less than 5%, less than 4%, less than 3%, less than 2%, less than 1%, less than 0.1%, less than 0.01%, less than 0.001%, or any range between any two of these values. In an ideal case, the concentration of virus in the output stream would be 0% of the concentration of virus in the input stream.

While most facial masks and air filters provide a physical barrier to prevent entry of unwanted materials, the filter assemblies of this technology are surprisingly effective in that they not only capture or immobilize virus, but also inactivate, destroy, or otherwise render the virus not viable. The methods disclosed herein are also effective at generating a layered composite comprising a reduced amount of viable or active virus particles after a particular time after initial contact and immobilization of the virus on or in the layered composite, for example, after about 1 hour, after about 2 hours, after about 3 hours, after about 4 hours, after about 5 hours, or after about 6 hours. Virus viability can be measured upon initial contact with a layered composite and again after six hours of contact. Viability can be measured in any acceptable manner such as by counting plaque forming units (PFUs). The reduction in viability of any virus captured or otherwise immobilized in the layered composite after six hours of contact may be, for example, a reduction of at least about 90%, at least about 92%, at least about 94%, at least about 96%, at least about 98%, at least about 99%, and in an ideal situation reduced 100% (i.e., no viable virus is detected).

In another aspect, therefore, the present disclosure also provides a method of reducing or inhibiting transmission of a virus, such as a coronavirus, through the air, from one person infected with the virus to another person who is not infected with the virus, for example, by reducing the amount of virus that is expelled from the infected person through respiration and related functions into the air by ensuring the expelled air passes through a layered composite as disclosed herein. Likewise, a person who is not infected may protect themselves from inhaling virus in the air, and thereby avoiding infection by such virus, by drawing air through a layered composite as described herein.

### EXAMPLES

### Example 1: Preparation of Silver-Impregnated FLEXZORB™ Carbon Cloth

FLEXZORB® was impregnated with silver to a weight of 0.3% w/w to yield FM10 T230. Therefore, as used in the examples, FM10 is activated carbon cloth without silver and FM10 T230 is FM10 activated carbon cloth impregnated with about 0.3% w/w silver.

### Example 2: Effect/s of Silver and Number of Layer/s on Filtering Capacity

MS2 coliphage virus (Emesvirus zinderi) was used as a safe model virus for testing of air filters. MS2 has a smaller mean diameter than SARS-CoV-2 and should be more difficult to immobilize. The MS2 phage was a non-enveloped single stranded RNA coliphage of 23 nm in diameter. MS2 is additionally recommended by the UK's Health Protection Agency (HPA), now called Public Health England, as a very small, highly mobile virus that because of its size and mobility is difficult to capture. The SARS-CoV-2 virus is much larger than MS2 at 60 nm-140 nm. Additionally, SARS-CoV-2 is an enveloped virus, while MS2 is a non-enveloped virus. As a result of these factors, filters that can immobilize MS2 should perform well against SARS-CoV-2 and other pathogenic viruses.

Testing was performed using a Henderson Apparatus with a test method designed to test the filtration efficiencies of materials used to produce face masks. A suspension of virus in aqueous solution was nebulized forming a fine aerosol containing viable virus. The aerosol was then injected into an air stream of 30 L/min at a controlled relative humidity of >95%. This was designed to deliver a challenge of over 10⁹ MS2 coliphage. The filter efficiency was calculated by determining the airborne concentration of viable virus upstream and downstream of the sample material (5 cm diameter) using suitable aerosol sampling techniques and assay methods.

Input air loaded with MS2 virus measured in plaque forming units (PFU) was passed through the filter, and output air was counted to determine reduction in PFU count. Table 1 summarizes the results.

TABLE 1

| | Number | | Input PFU | Output PFU | % virus |
|---|---|---|---|---|---|
| Cloth | of layers | Silver | (× 10⁻¹⁰) | (× 10⁻⁹) | capture |
| FM10 | 1 | No | 1.230 | 11.10 | 9.76% |
| FM10 | 3 | No | 1.245 | 4.100 | 67.07% |
| FM10 | 4 | No | 1.415 | 1.200 | 91.52% |
| FM10 | 4 | No | 1.200 | 1.720 | 85.67% |
| FM10 T230 | 1 | Yes | 1.485 | 6.600 | 55.56% |
| FM10 T230 | 1 | Yes | 0.780 | 6.050 | 22.44% |
| FM10 T230 | 2 | Yes | 1.245 | 2.900 | 76.71% |
| FM10 T230 | 3 | Yes | 1.185 | 4.200 | 64.56% |
| FM10 T230 | 3 | Yes | 0.810 | 4.050 | 50.00% |
| FM10 T230 | 4 | Yes | 1.365 | 1.580 | 88.42% |

This example shows that increasing the number of layers increases capture and retention of virus (see rows 1-4). The use of impregnated silver significantly increases the capture and retention of virus in a single-layer filter (see row 5). With greater number of layers, the improvement from use of impregnated silver becomes less noticeable (see rows 6-10). It is believed that attractive forces within the activated carbon cloth layers assist in the capture of the virus, while the impregnated silver assists in inactivating or destroying the bound virus.

### Example 3: Reverse Air Flow Test

A 4-layer filter of FM10 was challenged with 1.200×10¹⁰ PFU of MS2 coliphage virus in an input airstream. The output airstream had 1.720×10⁹ PFU, indicating an 85.67% capture/retention of MS2 virus on the filter.

The filter sample was next tested for retention of MS2 virus after being exposed to a clean air flow. The filter containing 3.93×10⁹ PFU of the captured virus was exposed to a clean air flow in the opposite direction of the original capture air flow. Only 7.05×10³ PFU of virus was eluted from the filter, indicating a 99.9998% retention.

### Example 4: Evaluation of Viral Destruction by Carbon Filter

Immobilized MS2 virus was counted after immobilization (T₀) and six hours later (T₆). A single layer of FM10 woven carbon cloth was used, with an HPA (Health Protection Agency) cloth as a negative control. Physical properties of the two samples were similar.

Standard well-established microbial generation and retrieval methods were used to test 1 inch (2.54 cm) square samples against MS2 coliphage. The samples were first sterilized and then contaminated with 100 μL of the MS2 coliphage followed by culture assay testing for microbial activity at 0 hours and 6 hours. During this time, the samples were incubated at 37° C. at a relative humidity of >40%.

For the test FM10 carbon cloth, the MS2 virus PFU at T₀ was 1.23×10⁷, and at T₆ was 8.90×10⁵. This indicates that the material is 92.76% effective at reducing growth after six hours of contact.

For the test FM10 T230 woven carbon cloth, the MS2 virus PFU at T₀ was 1.23E×10⁷, and at T₆ was 2.30×10⁵. This indicates that the material is 98.13% effective at reducing growth after six hours of contact. Addition of silver provided an increase in performance.

For the HPA control, the MS2 PFU at T₀ was 1.69×10⁷, and at T₆ was 1.75×10⁷. This indicates that the negative control had no effect at reducing virus viability after six hours of contact.

### Example 5: Examples of Filter Assemblies

Table 2 describes several embodiments of composites according to the present disclosure, which will be referred to by their letter designation throughout the Examples.

TABLE 2

| | Composite | | | | | |
|---|---|---|---|---|---|---|
| Layer | A | B | C | D | E | F |
| Outer | Daltex PP | Daltex50 PP | Daltex PP | Daltex PP | Daltex PP | Colback ® |
| | | | | | | PWD |
| Protective | — | Melt-blown | Melt-blown | Melt-blown | — | — |
| | | PP | PP | PP | | |
| ACC | FM10 T230 | FM10 T230 | FM10 T230 | FM10 T230 | FM10 T230 | FM10 T230 |
| ACC | FM10 T230 | FM10 T230 | — | — | — | FM10 T230 |
| Inner | SLB30 | SLB30 | SLB30 | Daltex PP | Melt-blown | SLB30 |
| | | | | | PP | |

SLB30 is a nonwoven viscose material with a weight of 30 g/m². The DALTEX® PP used in the Examples of Table 2 is spunbond polypropylene (PP) with a weight of 50 g/m² (DALTEX® 50). The melt-blown PP has a weight of 60 g/cm².

### Example 6: Effect of a Protective Membrane Layer

The effect of including a protective membrane layer in a composite was investigated by challenging each composite with aerosol containing MS2 virus. The dynamic testing was carried out using the Henderson Apparatus with a test method designed to test the filtration efficiencies of materials used to produce face masks. A suspension of micro-organisms in aqueous solution was nebulized forming a fine aerosol containing viable micro-organisms. The aerosol was then injected into an air stream of 30 L/min at a controlled relative humidity of greater than 95%. This was designed to deliver a challenge of over 10⁹ MS2 coliphage. The filter efficiency was calculated by determining the airborne concentration of viable micro-organisms upstream and downstream of the sample material (5 cm diameter) using suitable aerosol sampling techniques and microbial assay methods. Results are shown in Table 3 below.

TABLE 3

| | Protective | Number of | Viral |
|---|---|---|---|
| Composite | Membrane | ACC Layers | Capture % |
| A | No | 2 | 84.62 |
| B | Yes | 2 | 99.92 |
| C | Yes | 1 | 99.88 |

### Example 7: Effect of Outer Layer Weight

Composites were subjected to the same MS2 challenge as detailed in Example 6. Two layers of FLEXZORB® FM10 T230 woven carbon cloth were combined with an outer layer of DALTEX® spunbond polypropylene (PP) or a COLBACK® Pro PWD PP/PET non-woven material. Different weights of each were tested. In all filter assemblies, SLB, a non-woven viscose material with a weight of 30 g/m² (SLB30) was used as the inner layer. In all assemblies, the outer layer was laminated to one FLEXZORB® FM10 T230 layer and the inner layer was laminated to another, separate layer of FLEXZORB® FM10 T230. The two FLEXZORB® FM10 T230 layers were not laminated together. SHARNET® adhesive was used for all laminations (SHARNET® is a registered trademark of Bostik, Inc., Wauwatosa, Wis., USA). Virus capture testing was carried out, with the results shown in Table 4. These results show that increasing the weight of the outer layer increases the amount of virus captured. There was some scatter in the results with two obvious outliers. It was difficult to determine from the data whether the DALTEX® material was more effective than the COLBACK® material. Although increasing the weight of the outer layer increased the level of protection, the effect of the increased weight on the air permeability of the composite must also be considered. Increasing the weight of the outer layer decreased the air permeability and caused the composite to become less flexible. Table 4 also shows the effect of increasing the weight of the outer layer on the air permeability of the composite.

TABLE 4

| | | | Air permeability |
|---|---|---|---|
| | Weight, | % Virus | (cm³/cm²/sec |
| Outer Layer Material | g/m² | Capture | at 10 mm H₂O) |
| DALTEX ® spunbond PP | 70 | 76.11 | 18.1 |
| | 60 | 71.24 | 13.2 |
| | 50 | 84.62 | 22.3 |
| | 40 | 56.14 | 22.2 |
| | 30 | 75.24 | 27.3 |
| | 20 | 28.42 | 25.5 |
| COLBACK ® PWD | 75 | 42.34 | — |
| | 50 | 75.74 | — |

Increasing the weight of the outer layer decreased air permeability, as expected. All of the air permeability values are reasonable for use in a personal face mask. Further, the tested composites perform equal to or better than other common face mask materials, such as FFP3 (available from 3M) or FFP3 (available from Spireor) in terms of virus capture and exhibit a higher air permeability, thereby providing a wearer with a more comfortable fit that is easier to breathe through. Quantitative comparisons, for example, are shown in Table 5 below.

TABLE 5

| | | Virus | | Air |
|---|---|---|---|---|
| | Viral | Collected in | Virus | permeability |
| | Challenge | Output Air | Capture | (cm³/cm²/sec at |
| Composite | (PFU × 10⁻¹⁰) | (PFU × 10⁻⁷⁾ | (%) | 10 mm H₂O) |
| FM10 | 3.15 | 3.65 | 99.88 | 18.12 |
| FFP3 (3M) | 1.18 | 32.5 | 97.25 | 8.38 |
| FFP3 (Spireor) | 0.755 | 3.25 | 99.57 | 5.92 |

### Example 8: Effect of Moisture

A FLEXZORB® FM10 T230 carbon filter was preconditioned at a relative humidity of greater than 95% air at 34° C. delivered at 500 mL volumes at a rate of 20 breaths per minute for six hours to simulate normal wearing and use conditions. A control sample of the same FLEXZORB® FM10 T230 carbon filter was used but without preconditioning. Both samples had excellent capture of MS2 coliphage virus. The preconditioned filter captured 99.61% of the virus, and the non-preconditioned filter captured 99.88% of the virus, demonstrating that moisture does not degrade the efficacy of the filter.

### Example 9: Evaluation of Filter Materials

Antiviral textiles can be used in clothing applications particularly in the medical industry. FLEXZORB® material in various weights was therefore combined with other textiles to form a composite which could potentially have been used in an anti-viral clothing application. One textile property often favored by clothing manufacturers is stretch. For this reason, FM30K and FM50K which were knitted variants of FLEXZORB® were used. FM30K and FM50K are both commercially-available knitted activated carbon cloths, having a 110 g/m² weight and 130 g/m² weight, respectively. FLEXZORB® FM30K T230 (FLEXZORB® FM30K with 0.3% w/w silver ions added) was combined with a nylon outer layer (nylon fabrics are commercially available from Hansel Textiles, part of the Freudenburg Group, Iserlohn, Germany) and a knitted polyester inner layer (standard white Permess; Permess B.V., Goor, Netherlands). The outer and inner materials chosen were also stretchy, hence the final FLEXZORB® containing composites retained their stretch. The layers within the composites were laminated together using SHARNET® adhesive, forming one-piece systems. These one-piece laminates could potentially be used alone to form a garment or could be used along with an outer layer where the FLEXZORB® composite would function as an inner lining layer. These composites were just two examples of the vast combinations where FLEXZORB® layers can be used as an anti-viral functional layer in a clothing system. The composites were tested for their ability to capture virus. The results are shown in Table 6.

TABLE 6

| | | Number of | |
|---|---|---|---|
| | Antiviral | Layers of | % Virus |
| Outer/Inner Layer | Material | Antiviral Material | Capture |
| Nylon/Knitted Polyester | FLEXZORB ® | 1 | 46.67 |
| | FM30K T230 | | |
| Nylon/Knitted Polyester | FLEXZORB ® | 1 | 40.487 |
| | FM50K T230 | | |

### Example 11: Pressure Drop Tests

The Delta P test is performed to determine the breathability of test articles by measuring the differential air pressure on either side of the test article using a manometer, at a constant flow rate (8 L/min). A lower pressure drop provides a more comfortable fit to a wearer. The Delta P test complies with EN 14683:2019, Annex C and ASTM F2100-19. Each sample was conditioned in 85±5% relative humidity and 21±5° C. for a minimum of 4 hours prior to testing. Table 7 below reports the results of the testing for each of five (5) samples of Composite D and Composite E.

TABLE 7

| Test | Composite D | | Composite E | |
|---|---|---|---|---|
| Article | Delta P | Delta P | DeltaP | Delta P |
| Number | (mm H₂O/cm²) | (Pa/cm²) | (mm H₂O/cm²) | (Pa/cm²) |
| 1 | 5.6 | 54.5 | 7.2 | 70.4 |
| 2 | 5.4 | 52.8 | 7.6 | 74.9 |
| 3 | 5.2 | 50.9 | 8.1 | 79.6 |
| 4 | 5.5 | 53.9 | 8.0 | 78.8 |
| 5 | 5.7 | 55.5 | 7.9 | 77.3 |

### Example 10: High Challenge Bacterial and Viral Filtration Testing

Five (5) samples of Composite D and Composite E were subjected to a bacterial (Staphylococcus aureus) challenge of greater than 10⁶ CFU. The challenge was aerosolized using a nebulizer and delivered to the test article at a fixed air pressure and flow rate of 30 liters per minute (LPM). The aerosol droplets were generated in a glass aerosol chamber and drawn through the test article into all glass impingers (AGIs) for collection. The challenge was delivered for a one-minute interval and sampling through the AGIs was conducted for two minutes to clear the aerosol chamber. The mean particle size (MPS) control was performed at a flow rate of 28.3 LPM using a six-stage, viable particle, Andersen sampler for collection.

This test procedure was modified from Nelson Laboratories, LLC (NL), standard BFE procedure in order to employ a more severe challenge than would be experienced in normal use. This method was adapted from ASTM F2101. All test method acceptance criteria were met. Testing was performed in compliance with US FDA good manufacturing practice (GMP) regulations 21 CFR Parts 210, 211 and 820. Table 8 below reports the bacterial filtering capacity. All samples of Composite D were challenged (area of 40 cm²) with 4.5×10⁶ CFU. The MPS for all Filter D composites was about 2.7 μm. For Composite D, test article 1, the plate counts fell slightly below the countable limit of 25-250 CFU per plate. As a result, the total CFU recovered and the filtration efficiency are reported as approximations. All samples of Composite E were challenged (area of 40 cm²) with 3.4×10⁶ CFU. The MPS for all samples of Composite E was about 3.0 μm.

TABLE 8

| | CompositeD | | Composite E | |
|---|---|---|---|---|
| Test | Total CFU | Capture | Total CFU | Capture |
| Article | Recovered | Efficiency | Recovered | Efficiency |
| Number | (× 10⁻⁴⁾ | (%) | (× 10⁻⁴⁾ | (%) |
| 1 | ~3.2 | ~99.30 | 3.6 | 98.9 |
| 2 | 4.3 | 99.04 | 3.2 | 99.06 |
| 3 | 5.7 | 98.7 | 2.7 | 99.22 |
| 4 | 5.0 | 98.9 | 3.3 | 99.02 |
| 5 | 4.2 | 99.06 | 3.1 | 98.09 |

### Example 11: Viral Filtering Testing

Five (5) samples of Composite D and Composite E were subjected to a viral (ΦX174 bacteriophage) challenge of greater than 10⁶ PFU. The challenge was aerosolized using a nebulizer and delivered to the test article at a fixed air pressure and flow rate of 30 liters per minute (LPM). The aerosol droplets were generated in a glass aerosol chamber and drawn through the test article into all glass impingers (AGIs) for collection. The challenge was delivered for a one-minute interval and sampling through the AGIs was conducted for two minutes to clear the aerosol chamber. The mean particle size (VIPS) control was performed at a flow rate of 28.3 LPM using a six stage, viable particle, Andersen sampler for collection. The VFE at an Increased Challenge Level test procedure was adapted from ASTM F2101.

This test procedure was modified from Nelson Laboratories, LLC (NL), standard VFE test procedure in order to employ a more severe challenge than would be experienced in normal use. All test method acceptance criteria were met. Testing was performed in compliance with US FDA good manufacturing practice (GMP) regulations 21 CFR Parts 210, 211 and 820.

Table 9 below reports the viral filtering capacity of each filter type. Composite D, Article 1 was subjected to a challenge of 5.4×10⁶ PFU and Composite D, Articles 2-5 were subjected to a challenge of 3.3×10⁶ PFUs. The MPS for Composite D, Article 1 was about 2.9 μm and about 3.0 μm for Composite D, Articles 2-5. All samples of Composite E were subjected to a challenge of 3.1×10⁶ PFU. The MPS for all samples of Composite E was about 3.0 μm

TABLE 9

| | Composite D | | Composite E | |
|---|---|---|---|---|
| Test | Total PFU | | Total PFU | |
| Article | Recovered | Filtration | Recovered | Filtration |
| Number | (× 10⁻⁴) | Efficiency (%) | (× 10⁻⁴) | Efficiency (%) |
| 1 | 0.15 | 97.2 | 6.3 | 98.0 |
| 2 | 8.2 | 97.5 | 4.9 | 98.4 |
| 3 | 9.9 | 97.0 | 7.2 | 97.6 |
| 4 | 9.0 | 97.3 | 5.5 | 98.2 |
| 5 | 7.9 | 97.6 | 5.9 | 98.1 |

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of filtering an air stream that contains a virus or which is suspected of containing a virus comprising:
passing an input air stream from an inlet face through a layered composite to an output face and thereby producing an output air stream having a virus concentration that is less than the virus concentration in the input air stream, wherein the layered composite comprises:
an inner layer oriented towards or constitutes the inlet face;
at least one layer of activated carbon cloth adjacent to the inner layer, and
an outer layer comprising a non-woven polymer, the outer layer oriented towards or constitutes the outlet face and adjacent to the at least one layer of the activated carbon cloth, wherein the layered composite is contained within a filter or a face mask.

2. The method of claim 1, wherein the activated carbon cloth comprises about 0.1% w/w to about 3.5% w/w silver.

3. The method of claim 1, wherein the outer layer comprises spunbond polypropylene.

4. The method of claim 3, wherein the spunbond polypropylene has a weight of about 40 g/cm² to about 60 g/cm².

5. The method of claim 1, wherein the inner layer comprises a spunbond polyolefin.

6. The method of claim 1, wherein the layered composite further comprises a protective layer between the at least one layer of activated carbon cloth and the outer layer.

7. The method of claim 6, wherein the protective layer comprises melt-blown polyethylene.

8. The method of claim 1, wherein the virus is a coronavirus.

9. The method of claim 1, wherein the virus is SARS-CoV-2.

10. A layered composite for the removal of a virus from an air stream comprising:
an inner layer oriented towards or constitutes the inlet face;
at least one layer of activated carbon cloth adjacent to the inner layer, and
an outer layer comprising a non-woven polymer, the outer layer oriented towards or constitutes the outlet face and adjacent to the at least one layer of the activated carbon cloth, wherein the layered composite is contained within a filter or a face mask.

11. The layered composite of claim 10, wherein the activated carbon cloth comprises about 0.1% w/w to about 3.5% w/w silver.

12. The layered composite of claim 10, wherein the activated carbon cloth comprises about 0.1% w/w to about 0.5% w/w silver.

13. The layered composite of claim 10, wherein the outer layer comprises spunbond polypropylene.

14. The layered composite of claim 13, wherein the spunbond polypropylene has a weight of about 40 g/cm² to about 60 g/cm².

15. The layered composite of claim 10, wherein the inner layer comprises a spunbond polyolefin.

16. The layered composite of claim 10, wherein the layered composite further comprises a protective layer between the at least one layer of activated carbon cloth and the outer layer.

17. The layered composite of claim 16, wherein the protective layer comprises a non-woven polyolefin.

18. The layered composite of claim 16, wherein the protective layer comprises melt-blown polyethylene.

19. The layered composite of claim 10, wherein the layered composite comprises one or two layers of activated carbon cloth.

20. The layered composite of claim 1, wherein the layered composite comprises one or two layers of activated carbon cloth.
